(19) United States
(12) Patent Application Publication
(10) Pub. No.: US 2004/0267690 A1
(43) Pub. Date: Dec. 30, 2004

(54) Integrated development environment with context sensitive database connectivity assistance

(75) Inventors: Kulvir S. Bhogal, Fort Worth, TX (US); Hung T. Dinh, Austin, TX (US); Teng S. Hu, Austin, TX (US)

Correspondence Address: IBM CORP (YA), C/O YEE & ASSOCIATES PC, P.O. BOX 802333, DALLAS, TX, 75380, US

(73) Assignee: International Business Machines Corporation, Armonk, NY

(21) Appl. No.: 10/607,564

(22) Filed: Jun. 26, 2003

(51) Int. Cl. G06F 7/00

(52) U.S. Cl. 707/1

(57) ABSTRACT

A context sensitive database connectivity assistance tool is provided in an integrated development environment. The user provides database information for each connection to be used in a project. The database information may include schema name, database name, username, password, port number, etc. When a user is coding a database related statement, such as a structured query language statement, the user may highlight the statement and access the database connectivity assistance tool. The assistance tool prompts a user to disambiguate table and column names. Metadata may also be provided to the user for the type of column. The user may also set values and conditions for columns in database related statements.

### BACKGROUND OF THE INVENTION

1. Technical Field

The present invention relates to software development and, in particular, to Java database connectivity. Still more particularly, the present invention provides a method, apparatus, and program for providing Java database connectivity assistance in an integrated development environment.

2. Description of Related Art

Java is an object-oriented programming language designed to generate applications that can run on all hardware platforms, small, medium and large, without modification. Java was modeled after C++, and Java programs can be called from within hypertext markup language (HTML) documents or launched stand alone. When a Java program called from a Web page runs on a user's machine, it is called a “Java applet.” When a Java program is run on a Web server, it is called a “servlet.” When a Java program runs as a stand-alone, non Web-based program on a user's machine, it is simply a “Java application.”

An integrated development environment (IDE) is a set of programs run from a single user interface for software development. For example, programming languages often include a text editor, a compiler, and a debugger, which are all activated and function from a common menu. However, when coding Java database connectivity in Java IDEs, such as VisualAge for Java from IBM Corporation, the user frequently incorporates database related statements. Database related statements may include, for example, structured query language (SQL) statements. These statements usually require knowledge of the data model involved and the tables being affected.

Currently, integrated development environments do assist the coder in his/her efforts. However, the programmer typically would need to open more application windows in order to find out the exact definitions of the tables and columns in the databases being used. That is, the programmer has to open the control centers for the database management systems, open the databases, open the tables, and then open the schema to see the column definition for each column being referenced in a statement.

Therefore, it would be advantageous to provide an improved code assist feature that takes into account that a programmer might be interacting with a database.

### SUMMARY OF THE INVENTION

The present invention provides a database connectivity assistance tool in an integrated development environment. The user provides database information for each connection to be used in a project. The database information may include schema name, database name, username, password, port number, etc. When a user is coding a database related statement, such as a structured query language statement, the user may access the database connectivity assistance tool. If there is a plurality of databases being used, the database connectivity assistance tool may determine whether a table name is specified unambiguously. If the table exists in more than one of the pre-specified database connections, then the assistance tool prompts the user to specify to which database the statement is referring. Once the database and table are identified, the user may choose from a list of available column names to complete a database related statement. Metadata may also be provided to the user for the type of column. The user may also set values and conditions for columns in database related statements.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram illustrating a data processing system in which the present invention may be implemented;

FIG. 3 depicts an example integrated development environment in accordance with a preferred embodiment of the present invention;

FIGS. 4A-4M are example screens of display for an integrated development environment in accordance with a preferred embodiment of the present invention;

FIG. 5 is a flowchart illustrating the operation of an integrated development environment with a context sensitive database assistance tool in accordance with a preferred embodiment of the present invention; and

FIG. 6 is a flowchart illustrating the operation of a database information update mechanism in accordance with a preferred embodiment of the present invention.

### DETAILED DESCRIPTION OF THE PREFERRED EMBODIMENT

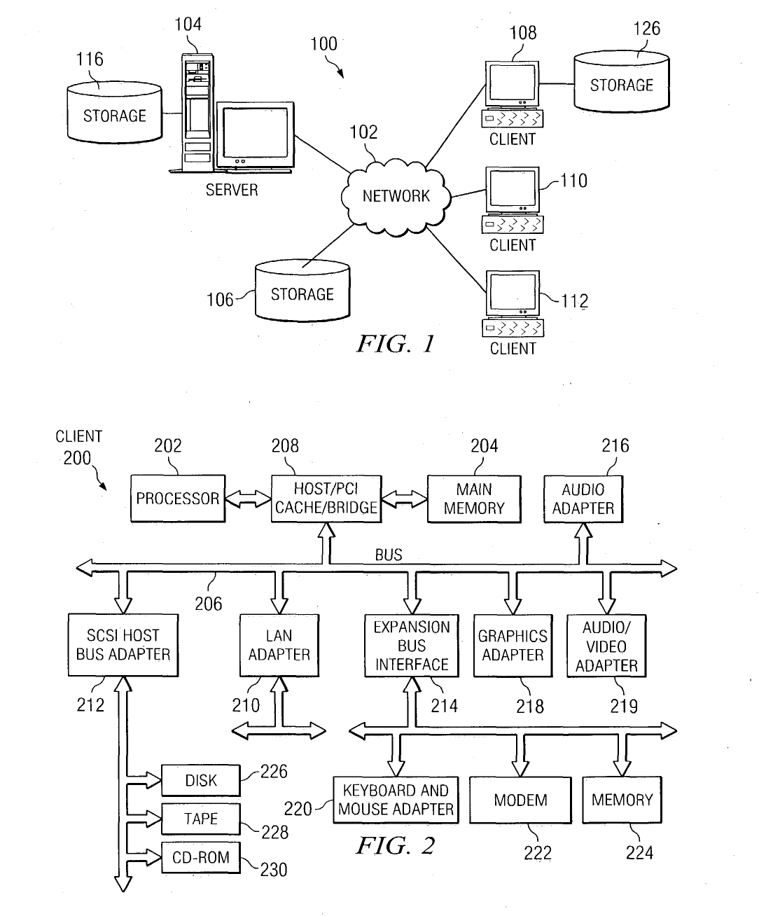

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

A programmer may code an application that accesses one or more databases. The programmer may code the application using a client, such as one of clients 108, 110, and 112. The application may be coded using an integrated development environment (IDE). The database may be stored, for example, in storage unit 106. In another example, the application may access a database in storage unit 116 through server 104 or to a local database in storage 126.

When coding Java database connectivity, in Java IDEs, such as VisualAge for Java from IBM Corporation, the user frequently incorporates database related statements, such as structured query language (SQL) statements. These statements usually require knowledge of the data model involved and the tables being affected.

In accordance with a preferred embodiment of the present invention, an integrated development environment includes a database connectivity assistance tool. The user provides database information for each connection to be used in a project. The database information may include schema name, database name, username, password, port number, etc. This IDE is included in the client, such as client 108. The connections may include connections to databases in one or more of storage 106, storage 116, and storage 126.

When a user is coding a database related statement, such as a structured query language (SQL) statement, the user may highlight the statement and access the database connectivity assistance tool for context sensitive assistance. If there is a plurality of databases being used, the database connectivity assistance tool determines whether the table is specified ambiguously. If the table exists in more than one of the pre-specified database connections, then the assistance tool prompts the user to specify to which database the statement is referring. If the database and table are unambiguous, the assistance tool may provide column selection, value set, and/or search condition user interfaces. Other context sensitive assistance may also be provided to guide the user in completing a database related statement.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

With reference now to FIG. 2, a block diagram illustrating a data processing system is depicted in which the present invention may be implemented. Data processing system 200 is an example of a client computer. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards.

In the depicted example, local area network (LAN) adapter 210, SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. Small computer system interface (SCSI) host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system, such as Windows XP, which is available from Microsoft Corporation. An object oriented programming system such as Java may run in conjunction with the operating system and provide calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

As another example, data processing system 200 may be a stand-alone system configured to be bootable without relying on some type of network communication interfaces. As a further example, data processing system 200 may be a personal digital assistant (PDA) device, which is configured with ROM and/or flash ROM in order to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

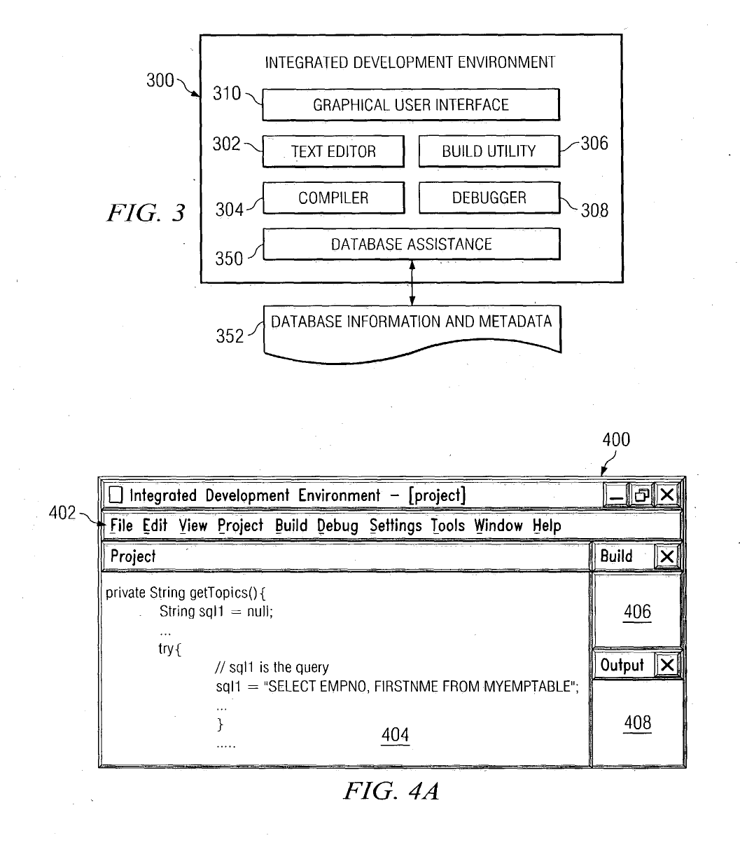

FIG. 3 depicts an example integrated development environment in accordance with a preferred embodiment of the present invention. Integrated development environment (IDE) 300 includes a set of tools or programs run from a single interface. In the depicted example, the interface is graphical user interface (GUI) 310; however, the interface may be a non-graphical interface, such as a command line interface.

In the example, shown in FIG. 3, the set of tools includes text editor 302, compiler 304, build utility 306, and debugger 308; however, more or fewer tools may be included within the scope of the present invention. For example, IDE 300 may include two or more compilers. Alternatively, IDE 300 may not include a build utility.

In accordance with a preferred embodiment of the present invention, the IDE includes database assistance tool 350. The user provides database information and metadata 352 for each connection to be used in a project. The database information may include schema name, database name, username, password, port number, etc. The database assistance tool may connect to each connection and retrieve the data model information and store this information locally at 352.

A database data model may change. For example, a table or column may be added to a particular database. In accordance with a preferred embodiment of the present invention, the database data model is retrieved from the database itself, based on the connectivity information provided by the user. Thus, the IDE may update the local database data model information from the actual connection periodically or whenever a connection is possible. For example, a developer may update database data model information for a plurality of connections in a project and use the IDE on an airplane or some other location where a connection to the database is not possible or practical.

When a user is coding a database related statement, such as a structured query language statement, the user may highlight a database related statement and access database connectivity assistance tool 350. If there is a plurality of databases being used, the database connectivity assistance tool determines whether the table is specified ambiguously. If the table exists in more than one of the pre-specified database connections, then the assistance tool prompts the user through GUI 310 to specify to which database the statement is referring. Once the database and table are identified, the database assistance tool may provide a list of available column names through the GUI. The user may then navigate the database assistance tool interfaces to populate the database related statement until the statement is complete.

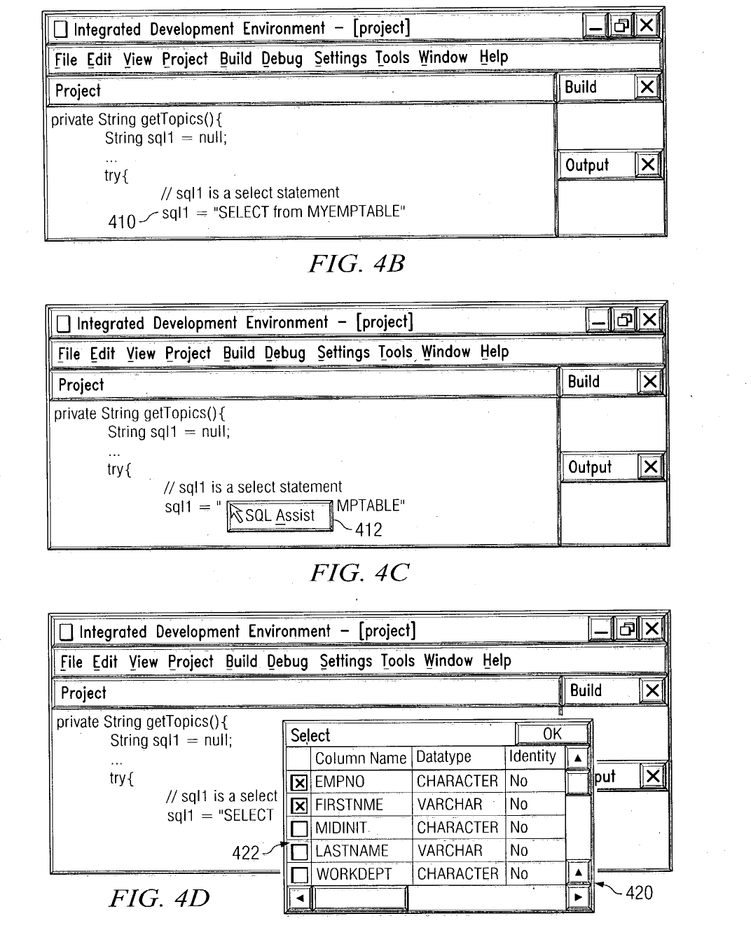

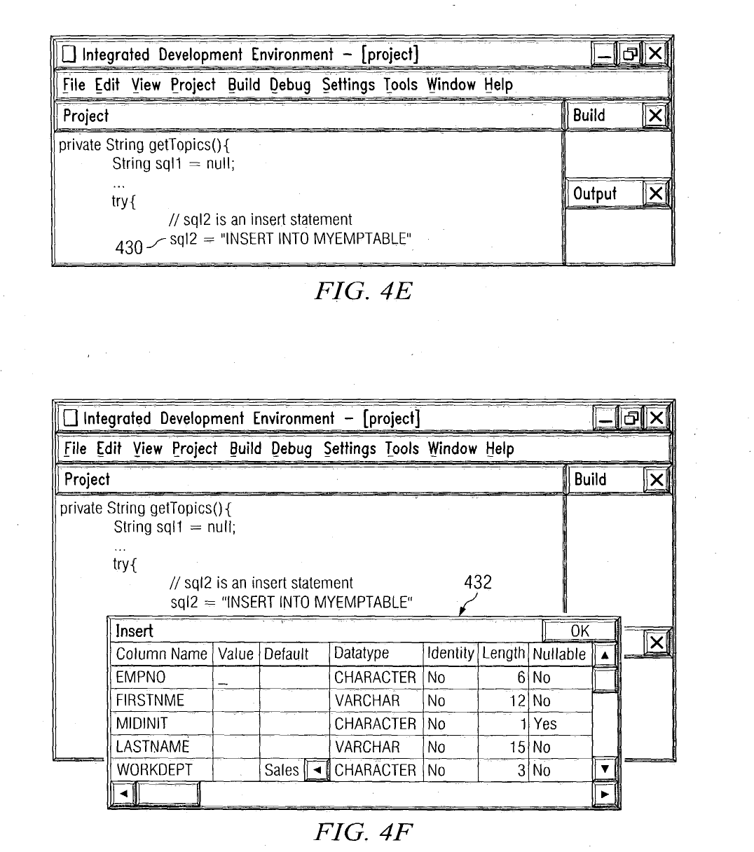

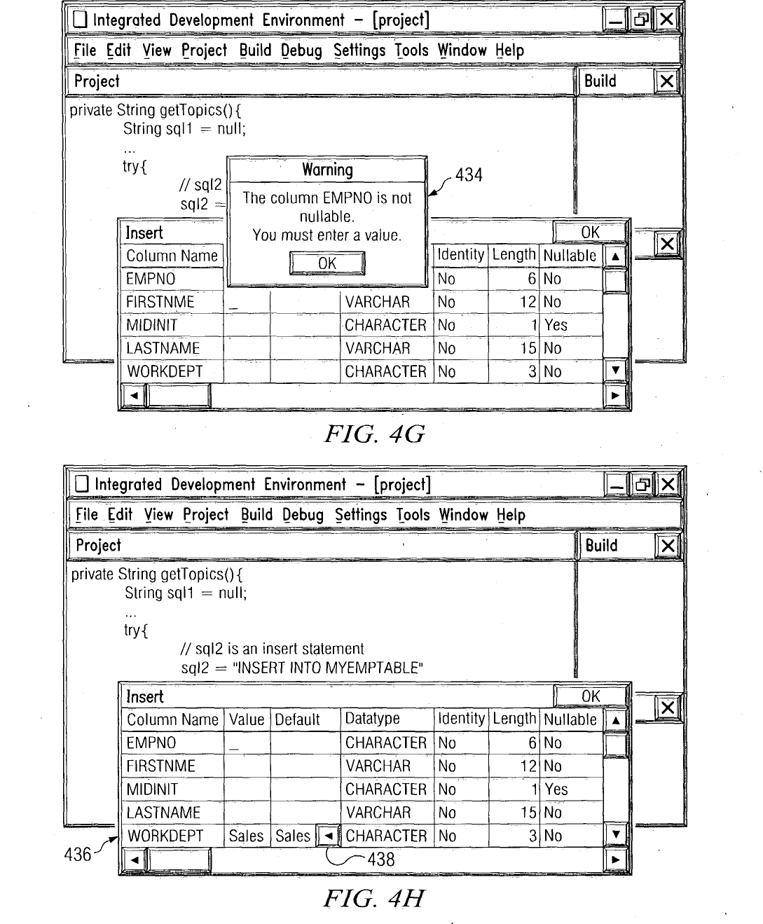

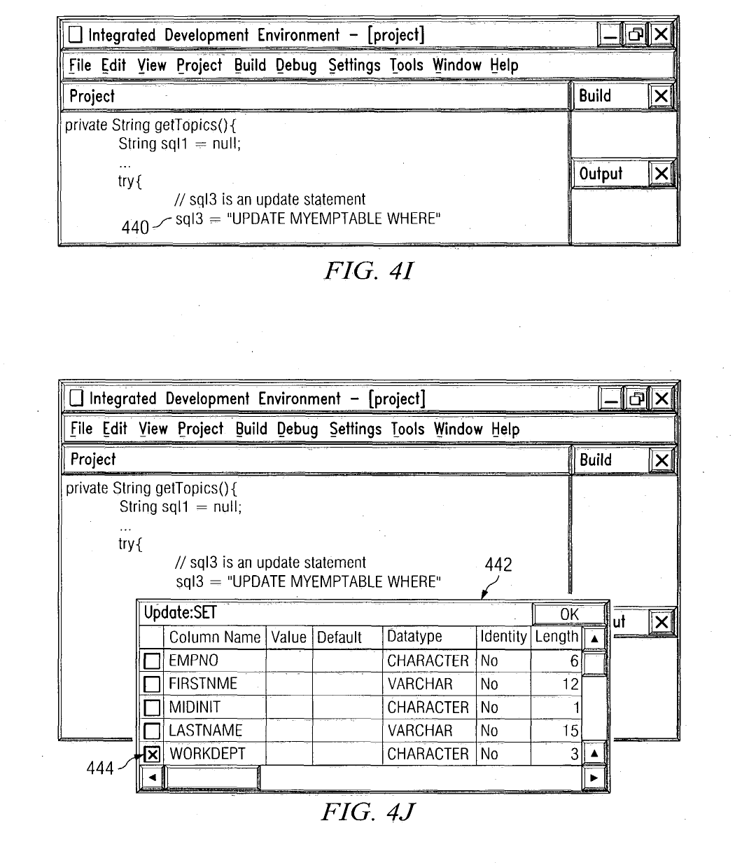

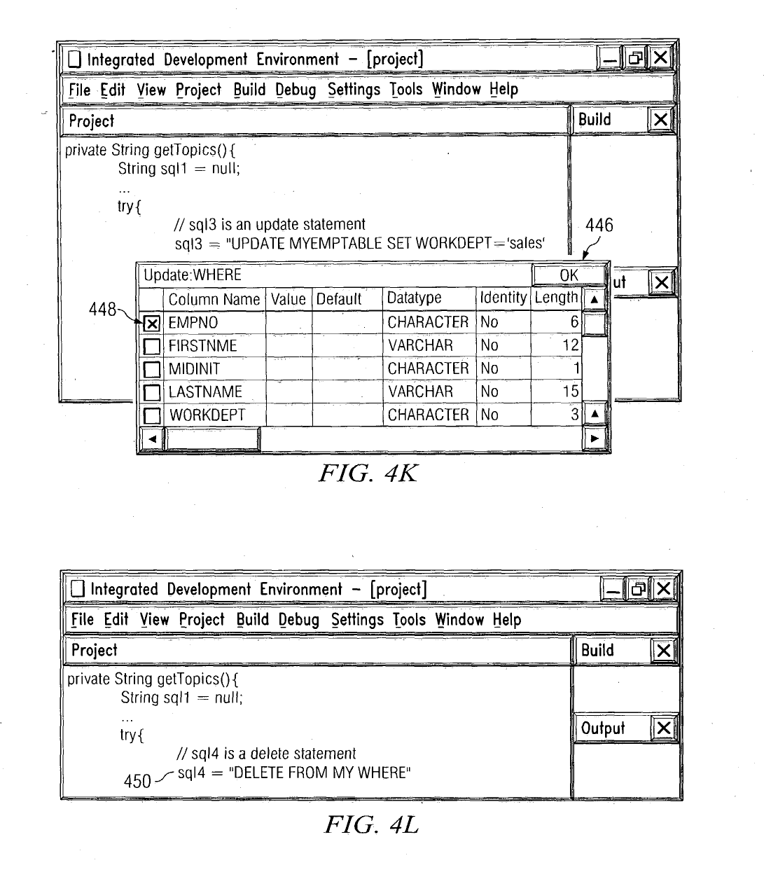

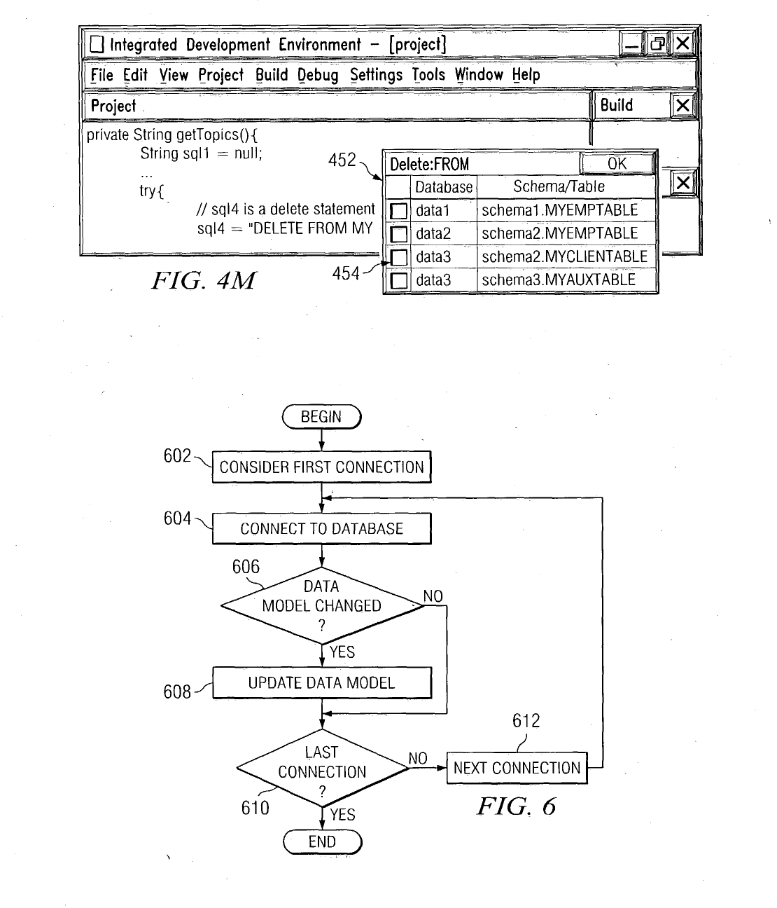

Next, with respect to FIGS. 4A-4K, example screens of display for an integrated development environment are shown in accordance with a preferred embodiment of the present invention. More particularly, FIG. 4A illustrates IDE window 400, which includes menu bar 402. Menus to be selected from menu bar 402 may include “File,” “Edit,” “View,” “Project,” “Build,” “Debug,” “Settings,” “Tools,” “Window,” and “Help.” However, menu bar 402 may include fewer or more menus, as understood by a person of ordinary skill in the art. Alternatively, IDE window 400 may include no menu bar depending upon the implementation.

The IDE window also includes project display area 404 in which project code is entered. The IDE window may also include build display area 406 and output display area 408. The build display area may display, for example, a build script or build log. The output display area may display other output messages for the project.

In the depicted example, project display area 404 includes example code in which an entire SQL statement is entered. The SQL statement is as follows:

sql1=“SELECT EMPNO, FIRSTNME FROM MYEMPTABLE”;

The developer must hard code the column names in the query, which means the developer must know the column names first.

With reference to FIG. 4B, the IDE window is shown without hard coding the entire SQL statement. The developer begins SQL statement 410 as follows:

sql1=“SELECT from MYEMPTABLE”

The developer may then activate the context sensitive database assistance tool, such as by right clicking the SQL statement, choosing the assist tool from a menu, depressing a function key or keyboard shortcut, or the like.

FIG. 4C illustrates the IDE window with a right-click menu 412, which may result from right clicking on the SQL statement. In this example, the right-click menu includes only one item, “SQL Assist.” However, the right-click menu may include more items for assisting the user with an SQL statement or other code.

Next, with reference to FIG. 4D, database assistance interface window 420 is shown in accordance with a preferred embodiment of the present invention. Interface window 420 presents a column selection interface including column selection checkboxes 422 for the “select” statement shown in FIG. 4C. Using interface window 420, the user may select columns to select from the table MYEMPTABLE specified in the highlighted statement. For example, in FIG. 4D the columns “EMPNO” and “FIRSTNME” are selected. In the example shown in FIG. 4D, the resulting statement would be as follows:

sql1=“SELECT EMPNO, FIRSTNME FROM MYEMPTABLE”

Turning to FIG. 4E, the IDE window is shown with an example “insert” SQL statement. The developer begins SQL statement 430 as follows:

sql2=“INSERT INTO MYEMPTABLE”

The developer may then activate the context sensitive database assistance tool.

FIG. 4F illustrates database assistance interface window 432, which presents a record insertion interface. Interface window 432 presents the existing columns and, using interface window 432, the user may enter values for a record to be inserted into the database. For example, in FIG. 4F a value for the column “EMPNO” is being entered. Data values for the record entered into the insertion interface are then added to the “insert” statement. Thus, the database assistance interface allows the user to populate a statement using context sensitive assistance.

The database assistance tool may also alert the user when errors are made or when an entered value does not comply with the metadata for the column. For example, in FIG. 4G, the user fails to enter a value for the column “EMPNO,” which is not nullable, meaning the column must have a value assigned. The database assistance tool presents a context sensitive warning 434 to alert the user of the error. The database assistance tool may alert the user to other errors or violations, such as syntax errors, values with improper length or data type, and the like.

Turning now to FIG. 4H, the column “WORKDEPT” 436 has a default value of “Sales.” The database assistance tool may automatically populate fields with their default values. Alternatively, the database assistance tool may include a control, such as button 438, for each column with a default value. The database assistance tool may then populate the field with the default value responsive to the user selecting button 438.

Next, with reference to FIG. 4I, the IDE window is shown with an example “update” SQL statement. The developer begins SQL statement 440 as follows:

sql3=“UPDATE MYEMPTABLE WHERE”

The developer may then activate the context sensitive database assistance tool.

FIG. 4J illustrates database assistance interface window 442, which presents a column set value interface. Interface window 442 presents the existing columns and, using interface window 442, the user may select columns using selection checkboxes 444 and set values for the selected columns in the “Value” field. For example, in FIG. 4H, the column “WORKDEPT” is selected and the user may enter a value, such as “sales,” into the value field to set a value for WORKDEPT in the “update” statement.

Next, FIG. 4K illustrates database assistance interface window 446, which presents a search condition interface. Interface window 446 presents the existing columns and, using interface window 446, the user may select columns using selection checkboxes 448 and set search condition values for the selected columns in the “Value” field. For example, in FIG. 4I the column “EMPNO” is selected and the user may enter a value, such as “0001,” into the value field to set a search condition value for WORKDEPT in the “update” statement.

The result of the examples shown in FIGS. 4J and 4K would be the following statement:

sql3=“UPDATE MYEMPTABLE SET WORKDEPT=‘sales’ WHERE EMPNO=‘0001’”

Thus, the developer may fully populate a database related statement using the context sensitive database assistance tool without having to know the database, table name, column name, etc.

The column set value interface and the search condition interface also include meta data for the columns to assist the user. For example, the user may enter information into the value field based upon the data type, length, precision, scale, nullable, and default fields shown in the interface window.

With reference to FIG. 4L, the IDE window is shown with an example “delete” SQL statement. The developer begins SQL statement 450 as follows:

sql4=“DELETE FROM MY WHERE”

The developer may then activate the context sensitive database assistance tool. In this example, the table “MY” may be ambiguous.

FIG. 4M illustrates database assistance interface window 452, which presents a table selection interface. Interface window 452 presents tables that satisfy the database term “MY” in the database related statement. Using interface window 452, the user may select a table using selection checkboxes 454.

In the example shown in FIG. 4K, the tables matching the term “MY” exist in multiple databases and may have different schemas. Thus, interface window 452 allows the user to disambiguate the table and the database with a single selection. In the example shown in FIG. 4M, table “schema1.MYEMPTABLE” exists in database “data1.” The table “schema2.MYEMPTABLE” exists in database “data2”. And both “schema2.MYCLIENTABLE” and “schema3.MYAUXTABLE” exist in the database “data3.”

In this example, the table name “MYEMPTABLE” exists in two different databases and in two different schemas. Therefore, the database assistance interface allows multiple levels of disambiguation. Alternatively, the database assistance tool may present separate database selection and table selection interfaces within the scope of the present invention. Furthermore, the tables that fit the table specified in the statement may not exist in separate databases, in which case the interface window may only present the table names for selection.

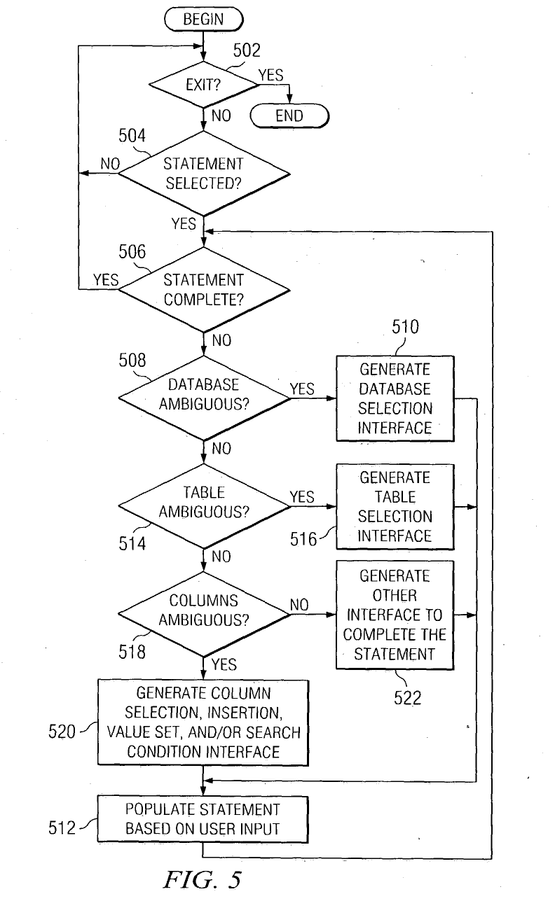

With reference to FIG. 5, a flowchart is shown illustrating the operation of an integrated development environment with a context sensitive database assistance tool in accordance with a preferred embodiment of the present invention. The process begins and a determination is made as to whether an exit condition exists (step 502). An exit condition may exist, for example, when the user closes the IDE. If an exit condition exists, the process ends.

If an exit condition does not exist in step 502, a determination is made as to whether a statement is selected (step 504). If a statement is not selected, the process returns to step 502 to determine whether an exit condition exists. If a statement is selected in step 504, a determination is made as to whether the selected statement is complete (step 506). If the statement is complete, the process returns to step 502 to determine whether an exit condition exists.

If the statement is not complete in step 506, a determination is made as to whether a database is ambiguous (step 508). If a database in the statement is ambiguous, the process generates a database selection interface (step 510), populates the statement based on user input (step 512) and returns to step 506 to determine whether the statement is complete.

If the database is not ambiguous in step 508, a determination is made as to whether a table is ambiguous (step 514). If a table is ambiguous, the process generates a table selection interface (step 516) and continues to step 512 to populate the statement based on user input. Thereafter, the process returns to step 506 to determine whether the statement is complete.

If a table is not ambiguous in step 514, a determination is made as to whether column information is ambiguous in the statement (step 518). If column information is ambiguous, the process generates a column selection, insertion, value set, and/or search condition interface (step 520) and continues to step 512 to populate the statement based on user input. Thereafter, the process returns to step 506 to determine whether the statement is complete.

If column information is not ambiguous in step 518, the process generates other interfaces with context sensitive assistance to complete the statement (step 522) and continues to step 512 to populate the statement based on user input. Thereafter, the process returns to step 506 to determine whether the statement is complete.

With reference now to FIG. 6, a flowchart illustrating the operation of a database information update mechanism in accordance with a preferred embodiment of the present invention. The process begins and considers the first database connection (step 602). Then, the process connects to the database (step 604) and a determination is made as to whether the data model for the database has changed (step 606).

If the database data model has changed, the process updates the locally stored database data model (step 608) and a determination is made as to whether the database connection is the last connection in the project (step 610). If the database connection is the last connection, the process ends.

If, however, the database connection is not the last connection in the project in step 610, the process considers the next database connection (step 612) and returns to step 604 to connect to the next database. Returning to step 606, if the data model has not changed, the process continues to step 610 to determine whether the database connection is the last connection in the project.

Thus, the present invention solves the disadvantages of the prior art by providing a context sensitive database connectivity assistance tool in an integrated development environment. The user provides database information for each connection to be used in a project. The database information may include schema name, database name, username, password, port number, etc. When a user is coding a database related statement, such as a structured query language statement, the user may highlight a table name and access the database connectivity assistance tool. If there is a plurality of databases being used, the database connectivity assistance tool determines whether the table is specified ambiguously. If the table exists in more than one of the pre-specified database connections, then the assistance tool prompts the user to specify to which database or table the statement is referring. Once the database and table are identified, the user may choose from a list of available column names to complete the database related statement. Metadata may also be provided to the user for the type of column. The user may also set values and conditions for columns in database related statements.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for providing context sensitive database assistance in an integrated development environment, the method comprising:
receiving a database query statement;
responsive to activation of a database assistance function, generating a database assistance interface based on at least a portion of the database query statement and database information for each database to be used in a project; and
responsive to user input, populating the database query statement.

2. The method of claim 1, wherein the database assistance interface includes one of a database selection interface, a table selection interface, a column selection interface, a record insertion interface, a column value set interface, and a search condition interface.

3. The method of claim 1, further comprising:
determining whether a table name in the database query statement is ambiguous,
wherein the database assistance interface includes a table selection interface for selecting a table from a plurality of candidate tables.

4. The method of claim 3, wherein the plurality of candidate tables exist in a plurality of databases.

5. The method of claim 3, wherein the plurality of candidate tables exist in a plurality of schemas.

6. The method of claim 1, further comprising:
determining whether a column name in the database query statement is ambiguous,
wherein the database assistance interface includes a column selection interface.

7. The method of claim 1, wherein the database assistance interface presents metadata to assist a user.

8. The method of claim 1, further comprising:
receiving database information for each database to be used in the project; and
storing a local data model for each database.

9. The method of claim 8, wherein the step of storing a local data model includes:
connecting to a database;
retrieving a data model for the database; and
storing the data model for the database locally.

10. The method of claim 8, wherein the step of storing a local data model includes:
connecting to each database;
determining whether a data model for each database has changed; and
responsive to a data model for a database having changed, updating a local data model for the database.

11. The method of claim 1, wherein the database information includes at least one of schema name, database name, username, password, and port number.

12. An apparatus for providing context sensitive database assistance in an integrated development environment, the apparatus comprising:
receipt means for receiving a database query statement;
generation means, responsive to activation of a database assistance function, for generating a database assistance interface based on at least a portion of the database query statement and database information for each database to be used in a project; and
assistance means, responsive to user input, for populating the database query statement.

13. The apparatus of claim 12, wherein the database assistance interface includes one of a database selection interface, a table selection interface, a column selection interface, a record insertion interface, a column value set interface, and a search condition interface.

14. The apparatus of claim 12, further comprising:
means for determining whether a table name in the database query statement is ambiguous,
wherein the database assistance interface includes a table selection interface for selecting a table from a plurality of candidate tables.

15. The apparatus of claim 12, further comprising:
means for determining whether a column name in the database query statement is ambiguous,
wherein the database assistance interface includes a column selection interface.

16. The apparatus of claim 12, further comprising:
means for receiving database information for each database to be used in the project; and
means for storing a local data model for each connection.

17. The apparatus of claim 16, wherein the means for storing a local data model includes:
means for connecting to a database;
means for retrieving a data model for the database; and
means for storing the data model for the database locally.

18. The apparatus of claim 16, wherein the means for storing a local data model includes:
means for connecting to each database;
means for determining whether a data model for each database has changed; and
means, responsive to a data model for a database having changed, for updating a local data model for the database.

19. The apparatus of claim 12, wherein the database information includes at least one of schema name, database name, username, password, and port number.

20. A computer program product, in a computer readable medium, for providing context sensitive database assistance in an integrated development environment, the computer program product comprising:
instructions for receiving database information for each connection to be used in a project;
instructions for receiving a database query statement;
instructions for responsive to activation of a database assistance function, generating a database assistance interface based on at least a portion of the database query statement; and
instructions for responsive to user input, populating the database query statement.
